(19) United States
(12) Patent Application Publication
(10) Pub. No.: US 2004/0111377 A1
(43) Pub. Date: Jun. 10, 2004

(54) Anonymous reporting and rewarding system and method

(76) Inventors: Robert Teberg, Crystal Lake, IL (US); Andrew Kauser, Crystal Lake, IL (US)

Correspondence Address: CHAPMAN AND CUTLER, 111 WEST MONROE STREET, CHICAGO, IL, 60603, US

(21) Appl. No.: 10/717,383

(22) Filed: Nov. 19, 2003

Related U.S. Application Data
(60) Provisional application No. 60/427,806, filed on Nov. 20, 2002.

(51) Int. Cl. G06F 17/60

(52) U.S. Cl. 705/74

(57) ABSTRACT

A method is disclosed for facilitating “whistle-blowing” by members of the public and individuals within public and private entities who learn of fraud and other misconduct perpetrated by or upon such entities. An organization is established that accepts anonymous “tips” and information about misconduct but maintains contact with the anonymous reporter. When sufficient information is in hand, the organization approaches the entity doing or suffering the misconduct. The organization offers to provide the information in order that corrective action, as stopping a polluting discharge to avoid a fine or stopping certain misconduct and suing to collect damages, can be taken by the entity. A reward is agreed on, together with a time that it will be paid and any contingencies in the reward. When the reward is paid, the major portion of it, less a service fee for the organization, is paid over either to the reporter or to a third party, as a charity or governmental body, designated by the reporter or the organization. Confirmation of the payment can be made to the anonymous reporter.

### CLAIM OF PRIORITY

I claim the priority of my co-pending provisional application, serial No. 60/427,806 filed Nov. 20, 2002.

### FIELD OF THE INVENTION

The invention relates to methods for encouraging “whistle-blowing”, i.e., reporting fraud, misconduct, and victimization of and by entities, while maintaining anonymity of the source of the report and helping to assure reliability to the information reported.

### BACKGROUND OF THE INVENTION

American society is based on rules and regulations and norms of behavior and conduct, which protect and benefit all of its people and institutions, including government, business, and non-profit entities. All citizens and residents should be ready, willing, and able to report fraud, waste, and abuse that they see or experience—simply because it is the right thing to do. However, it is well known that consequences of reporting such events can be devastating to an individual reporter. Whistleblowers in business firms often suffer severe emotional as well as financial stress, job loss, and retaliation from their employers and/or co-workers. Many individuals will not report misconduct because of these consequences.

Government fraud, waste, and misconduct may be remedied presently through “qui tam” claims or actions, as under the Federal False claims Act and its State counterparts. However, a claimant's identity, although technically protected, is not presently anonymous. A person's identity may be disclosed inadvertently by participants, or as a part of a lawsuit. Once a reporter's identity is discovered, he or she may be subjected to harassment. Qui tam actions have returned more than $9 billion to the federal government over the past 15 years. An individual can receive between 15 and 30 percent of the total recovery. In 2000, approximately $1.2 billion of the $1.5 billion collected under the False claims Act were the result of qui tam lawsuits. Payments to whistle-blowers for the 2000 fiscal year totaled more than $173 million. These amounts could be increased significantly if a reporter's identity were actually fully protected.

Likewise, persons who report apparent income tax fraud are promised anonymity, but lax security and the number of IRS employees who have access to various files make their identities easy to discover. The IRS paid approximately $3.3 million in 2001 and $10.8 million in 2000 to people who provided information used to collect back taxes. IRS Commissioner Charles Rossotti said, “82% of those who cheat on taxes are getting away with it because the IRS lacks the auditors to pursue them”. He also said that “by spending an additional $2.2 billion a year to expand the IRS staff, the agency could raise an extra $30 billion each year, most of it from people who now cheat and get away with it.” In addition, the Wall Street Journal has reported that, “IRS audit rates for individuals fell in fiscal 2000 to 0.49%, the lowest level since the slide began in the mid-1990s. That is down from 0.89% a year earlier and less than one-third the 1.68% rate taxpayers faced in 1995. For those earning $100,000 and up, the rate fell to 0.96% in fiscal 2000 from 1.40% a year earlier and from 2.97% in 1995. ‘Clearly, the declines we've seen in the past few years need to stop, or the fairness and effectiveness of our tax system will be undermined,’ IRS Commissioner Charles Rossotti, said.” The IRS estimates further that $20 billion to $40 billion of revenue is lost each year due to individuals' offshore tax scams. The IRS has estimated as many as two million U.S. taxpayers might be tapping offshore accounts with credit cards. An IRS consultant estimated that offshore schemes cost the government as much as $70 billion a year, but that estimate includes corporate offshore havens.

A May 11, 2000, Wall Street Journal article described how ethics programs and classes are not stemming employee misconduct. “Workers are seeing—but not necessarily reporting—widespread illegal and unethical conduct in the workplace, despite many corporate-ethics programs, according to a survey of more than 2,300 employees by KPMG LLP, New York. More than 75% of those surveyed said they had observed violations of the law or company standards in the previous 12 months. And while many workers indicated a willingness to report misdeeds, 61% thought management wouldn't administer impartial discipline.” “Among other things, workers noted sexual harassment, conflicts of interest, employee discrimination, deceptive sales practices, unsafe working conditions, and environmental breaches. ‘People are not reporting misconduct because they are not encouraged to do so,’ says Richard Girgenti, a KPMG executive. The study found that nearly 75% of workers believed cynicism, low morale, and indifference were to blame for misconduct. Workers said rewards or incentives for adhering to company standards would reinforce ethics programs.”

The National Insurance Crime Bureau reports that the cost of insurance fraud runs steep for all involved. The Bureau estimates that 10% of all insurance claims are fraudulent. The cost of insurance fraud each year is $96.2 billion. According to a published study by the Coalition Against Insurance Fraud (CAIF), fraud is among the most prominent cost components causing increased costs of insurance. The CAIF has estimated the annual loss figures relative to insurance fraud (apart from health insurance) to be approximately $26 billion. Apart from the CAIF figure, the life/disability segment of the insurance industry opines that approximately $1.5 billion is lost each year through fraudulent schemes. Estimated annual insurance fraud figures are as follows: Auto $12.3 billion; Homeowners $1.8 billion; Business/Commercial $12.0 billion; and Life/Disability $1.5 billion.

Some firms exist that will perform audits of other companies' accounts payable and procurement transactions to ensure that transactions are processed with accuracy. These firms search for over-payments made between companies. They operate on a contingent fee-based pricing model and are paid a percentage of actual documented recoveries. To date well over $1 billion has been recovered by these firms. While those firms' business model requires a review of the client's transactions in search of overpayments, the new entity of the present invention will operate differently. Someone in the organization that was over paid is aware of the error; because the new system protects anonymity and rewards charities the individual would chose the new entity's method and system to report the error. The existence of the new entity and its method and system will discourage companies from keeping over-payments.

The IRS estimates that the federal government is losing $195 billion per year in revenue due to underground economy activities. Individuals and businesses can deal in cash and/or use other schemes to try to conceal their activities and their actual tax liability from government licensing, regulatory, and taxing agencies. In addition, it is estimated that the underground economy is anywhere from 3 to 40% of the normal, open US economy. When businesses and individuals operate in the underground economy, they improperly reduce monies spent for insurance, payroll taxes, licenses, employee benefits, safety equipment, and safety condition monitoring. These types of employers then gain an unfair competitive advantage over businesses that comply with the various business laws, leading to unfair competition in the marketplace and higher taxes and expenses for law-abiding businesses.

### SUMMARY OF THE INVENTION

The invention enables an individual to report fraud, victimization, and misconduct anonymously and to reap any benefit, which may be donated to a charity, promised for such reporting. An entity is established to submit a report or a claim on behalf of a reporting individual, so that reporter will remain anonymous even to the entity.

According to the invention, an individual who discovers or is made aware of a fraud, victimization, or other misconduct can log into an Internet web site and create a unique user name and password. The individual then enters a detailed description of the fraud, etc., as on a template, and includes an estimation of the monies involved. The entity then reviews the claim and evaluates the information provided. If the information is sufficient, then a file is started by the entity. If the information is not sufficient, then a confidential message is posted to the individual on the entity's web site, available the next time the reporter logs in. The individual reporter then can provide additional information or details for reassessment of the report.

Once a file is opened, then a representative of the entity will assess how to process the information in order to report the fraud, misconduct, etc., to cure the situation and also to obtain a financial reward, either as indicated or one that is then negotiated with the victim of the misconduct. For instance, if the claim relates to Government waste and/or fraud, then a qui tam claim is initiated by the entity of this invention. If the claim relates to a public corporation that is polluting the environment, then a claim is initiated with the Environmental Protection Agency. If the claim relates to one company defrauding another then the company being defrauded is contacted. Without providing specifics, the entity will inquire of the injured party for instance if they know of, and if not if they are interested in acquiring, the information possessed. The entity then will negotiate a share of the recovery or savings along with an indemnification agreement protecting the entity as well as the identity of the original source. Once both parties execute a contract, then the entity will provide the information it has. When the victim recovers the funds, or an award is provided, then the entity will be paid accordingly. Once the entity has received payment, then the anonymous informant will be contacted by a further posting on the entity's website, through the unique but anonymous name and password. The entity then will remit the funds to a designated account, such as a charity of the reporter's choosing or another recipient, including perhaps the reporter himself or herself if anonymity can be assured. The entity will ask that the charity or other entity publicly acknowledge or publish the fact and the amount of the funds paid to them by the entity on behalf of an anonymous donor, together with a mention of the entity and the code word selected by or assigned to the reporter. This will ensure the original reporter that the funds were paid.

### BRIEF DESCRIPTION OF THE DRAWINGS

FIG. 1 is a flow chart showing the first steps of a method using the invention.

FIG. 2 is a further flow chart showing later steps of a method using the invention.

### DESCRIPTION OF THE PREFERRED EMBODIMENTS

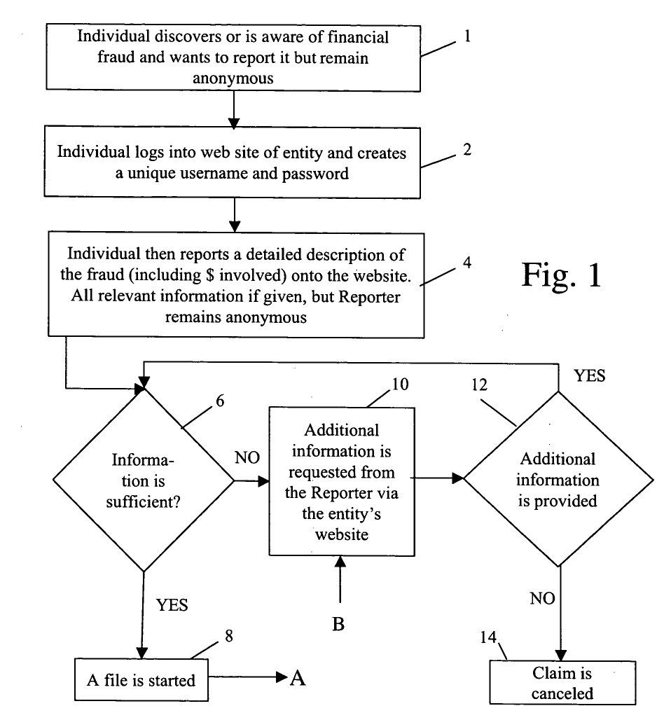

At step 1 in FIG. 1, an individual discovers or is made aware of some form of fraud, misconduct, victimization of and by entities, harassment or oppressive work environment claims and would like to report it but wishes also to remain anonymous. The individual communicates with an entity committed to carrying out this invention, as by logging into the entity's website, and creates a unique username and password, as at 2. The individual then enters a detailed description of the fraud, including the estimated dollar amount or value of the fraud, onto the website. He or she provides as much relevant information as available, while not entering his or her own name, as at 4.

An employee or agent of the entity will review the information to determine if it is sufficient in detail and scope, as at 6. If the information is deemed sufficient, a file is opened, as at 8. If the information is not deemed sufficient, a message is posted for the claimant to see the next time that he or she enters the site, explaining that the information provided was not sufficient to open a file and that the person needs to provide additional information to proceed 10. Additional information may then be provided, as at 12. If no additional information is provided, or if information provided is still not deemed sufficient, then the file may be closed as at 14 or another attempt may be made to request additional information from the claimant, as at B. Sometimes the entity may acquire added information from another source or by independent research or investigation; this information may be used to check the accuracy of the reporter's information or to add to the completeness of the claim that is made.

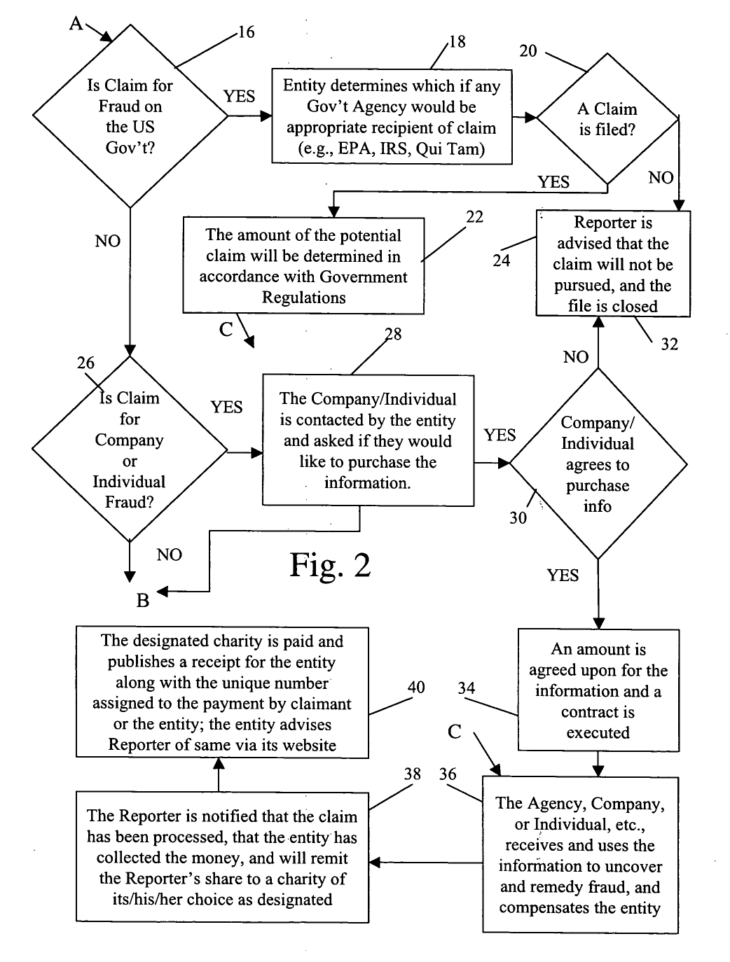

When sufficient information is in hand from the individual reporter in FIG. 1, at A, a determination is made as in FIG. 2 at A as to whether the fraud is related to Government, an individual, or a business or other entity, as a charity, not-for-profit institution, a school, etc. This determination will be used to decide how the file should be processed, as at 16. If it is a Government related fraud then an appropriate claim is filed with that agency in accordance with its policies and procedures, at 18, and a claim is submitted to the Government Agency, as at 20. The amount of the claim will be determined in accordance with the relevant government policy, procedure, or regulation 22, following the link C-C in FIG. 2. If the claim is rejected, then the entity will notify the claimant via the website, as at 24.

If a determination is made that the claim is for individual or business entity fraud, as at 26, then the injured individual or company will be contacted and an offer made or received for purchase of the information, as at 28. If the entity chooses not to purchase the claim information at an agreeable price, then the file may be closed, or a determination may be made that another person or entity also injured may be interested in the information. The claimant is notified via the website whether the file is open or closed, as at 32. If information is sold, an amount will be agreed to, which may or may not be contingent on results obtained. A contract is executed, at 34. The information is provided to the entity and, if the claim results in recovery as at 36, the entity is compensated in accordance with the contract 36 or the government regulation.

The claimant is notified via the web site of the payment, and the claimant is asked to which charity he or she would like to be awarded his or her share of the monies collected, as at 38. When the charity is paid, it publishes a receipt of the payment along with a unique number that the reporter selects or the entity assigns to the payment, as at 40. The claimant may also be advised confidentially via the entity's website that the monies have been paid, but the recipient's receipt is more reassuring to reporters. Other payment arrangements can be made, to the reporter or another, if anonymity can be assured, as through an attorney, or offshore, or such, as laws and tax codes permit.

These and other forms of the invention will be suggested by the above discussion to those of ordinary skill in the art. The invention is defined only by the methods set forth in the appended claims.

I claim as my invention:

1. A method of facilitating “whistle-blowing” by one or more anonymous individuals, the method comprising the steps of:
operating an independent service organization to which a person or persons may anonymously report fraud, misconduct, error, and other victimization of and by other persons or entities,
negotiating with the victimized or victimizing person or entity to obtain a reward on behalf of the person or persons making the report, and
collecting a reward from the victimized person or entity either directly for the reporting person or persons anonymously or indirectly by donating it on behalf of the reporting person or persons to a specified nonprofit or governmental entity.

2. The method of claim 1 wherein the reward is collected and passed to the specified entity on behalf of the anonymous reporting person or persons, and the reward is acknowledged by the specified entity's publishing notice of the donation by the service organization with a code chosen by one of the organization and the reporting person or persons, thereby giving notice of completion of the whistle blowing process.

3. The method of claim 1, wherein anonymous communication is provided between the service organization and the reporting person or person by way of postings on a publicly accessible bulletin board of the service organization.

4. The method of claim 3, wherein the bulletin board is an electronic one that is accessible over a global communications network and the reporting person or person selects his, her, or its own identifying code.

5. The method of claim 1, wherein the information is offered to the victimized person or entity and a reward is negotiated by the organization with the victimized person or entity for providing the information.

6. The method of claim 1, wherein the organization retains a fee from the reward monies and transfers only the balance to reporter or the specified entity.

7. A method of discouraging fraud and other misconduct in and among public and private bodies by facilitating “whistle-blowing” by persons who know of the misconduct but want to remain anonymous, the method comprising the steps:
operating an organization to which fraud and misconduct can be reported anonymously while retaining contact and communication for developing information and transmitting a reward;
accepting information as to specific instances of fraud and misconduct damaging to a public or private entity;
maintaining anonymity of the reporting person by affording contact and communication through an international global network by which the reporting person cannot be identified, but accepting a coded identifier for the reporting person to be used in postings at a site on the network when communication is needed;
communicating sufficient information from the reporting person to the affected entity to confirm knowledge of the misconduct and its perpetrator and offering more complete information if a reward comprising a part of the damage to be recovered is agreed to; and
passing at least a portion of the reward when received by the organization to one of the reporting person and a third party designated by the reporting person.

8. The method of claim 7, wherein receipt of the reward is acknowledged publicly by the third party in a public announcement of the payment by the organization together with a code provided by or for the reporter.
